(19) United States
(12) Patent Application Publication
(10) Pub. No.: US 2016/0135594 A1
(43) Pub. Date: May 19, 2016

(54) ADJUSTABLE STORAGE RACK SYSTEM FOR SPORTING GOODS AND OTHER ITEMS

(71) Applicant: BRUCE T. ANDERSON, San Clemente, CA (US)

(72) Inventor: BRUCE T. ANDERSON, San Clemente, CA (US)

(21) Appl. No.: 13/693,883

(22) Filed: Dec. 4, 2012

(51) Int. Cl. A47B 81/00; B62H 3/00

(52) U.S. Cl. CPC A47B 81/00; B62H 3/00

(57) ABSTRACT

The present device is directed to a storage product that is modular and adjustable, allowing for ease of storing a variety of sporting goods. Said device uses powder coated round tubing, covered in neoprene which slide into a uniquely designed “U Channel” fabricated rail system made from mild steel which is also powder coated, that is rugged, durable and allows the round tubing complete vertical adjustability. The present device generally provides a way to store large sports equipment such that the equipment is held securely away from the ground. A rack of some embodiments may be used to store various types of recreational equipment in an orderly fashion. The supports are optimally angled between 35 and 90 degrees for ease of use and supportability.

### RELATED APPLICATIONS

This application claims priority from U.S. Provisional Patent Application No. 61/579,263, filed Dec. 22, 2011, which is hereby incorporated by reference.

### BACKGROUND OF THE INVENTION

The present invention is directed to storage products that are modular and adjustable, allowing for ease of storing a variety of sporting goods. Some surfers and other sports enthusiasts use doweled wood cut into a 2×4 piece of wood or PVC material to make racks. Racks made of PVC don't hold an adequate amount of weight and are typically non-adjustable. Racks made of steel tubing typically are fabricated in a fixed hanger position which, doesn't have any adjustability, and are heavy and cumbersome.

The present invention uses powder coated round tubing, covered in neoprene which slide into a uniquely designed “U Channel” fabricated rail system made from mild steel which is also powder coated, that is rugged, durable and allows the round tubing complete vertical adjustability. This allows the user to adjust and store most sporting equipment or other, off the floor of the garage or room. It is relatively light and easy to install. It is designed to be mounted into the studs of a wall or can be installed into a concrete or block wall or material that can hold up to 1000 lbs. Once the stable (additional piece of steel attached to the rail to minimize horizontal wobble) vertical rails are installed, the hangers can be installed and adjusted to infinite positions without any tools required. This storage rack system was also designed for relatively low manufacturing costs/steps.

### OBJECTS OF THE INVENTION

The reason for the angle (45 degree) on two of the four hanger/carrier type configurations is for space savings in your garage. Some people need as much space as possible for their car. The two carriers at a 45 degree angle which saves some horizontal distance from the garage wall. Also, if you mount the rails around car window height, you can open your car door and clear the 45 degree hanger space saver.

The carrier types (45 degree and 90 degree) come in two lengths—18″ long and 25″ long (i.e. longer for wider objects—kayaks, two bikes, stand up paddle boards, etc) and shorter for 1 bicycle, surfboards, skis, snowboards, etc.). Any of the hangers can be configured/adjusted to the top or bottom of the rails along with having the 1″ increment adjustability for infinite variations. The entire system can hold up to 1000 lbs with each hanger/carrier holding up to 200 lbs. Again, four hanger/carrier types available.

The carriers that come straight out (90 degree) are really the easiest to use because you put the object you're going to store on the carrier straight in versus having to lift your object “over” the highest part of the 45 degree carrier and then down. The 45 degree types really “hold the items in place, secures it better” because the items are angled down and towards the wall.

The present invention comes with a pair of long (25″) 45 degree carriers and a pair of short 90 degree carriers, which either can be put on top or bottom. A customized system that might have two pair of short 90's or 1 pair of short 45's and 1 pair of long 90'. Two pair of hangers are standard. The four different set hangers, in pairs, are available to buy for different set ups. One can purchase more Rails/tracks so that you can continue to add or stack (each rail is 38″ long) on your system (like a train track) if you have the vertical space.

You can stack up to 8-10 boards on 1 pair of carrier's (see wall mount gallery pictures). So you could put a pair of long 45″ at the bottom of the rails, stack 8 boards on those carriers and then put either long or short 45's or 90's on the top of the rails for more storage or allow for putting the short 90's on the bottom and store your bike and fishing pole and the 45's up top for boards, skis, camping gear, etc.

### BRIEF DESCRIPTION OF THE DRAWINGS

FIG. 1 illustrates a storage rack according to a preferred embodiment of the invention.

### DESCRIPTION OF THE PREFERRED EMBODIMENT

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a way to store large sports equipment such that the equipment is held securely away from the ground. A rack of some embodiments may be used to store various types of recreational equipment in an orderly fashion. Such equipment may include skis, snowboards, kayaks, canoes, ladders, surfboards, stand-up paddle boards, bikes, camping gear, etc. The rack may be adjustable by appropriate increments (e.g., one inch increments). The rack may include a set of vertical rails (e.g., two rails) that may be attached to a vertical surface (e.g., a wall).

Each rail may include multiple padded loops (e.g., two loops) adapted to support and/or or hold multiple pieces of equipment at once.

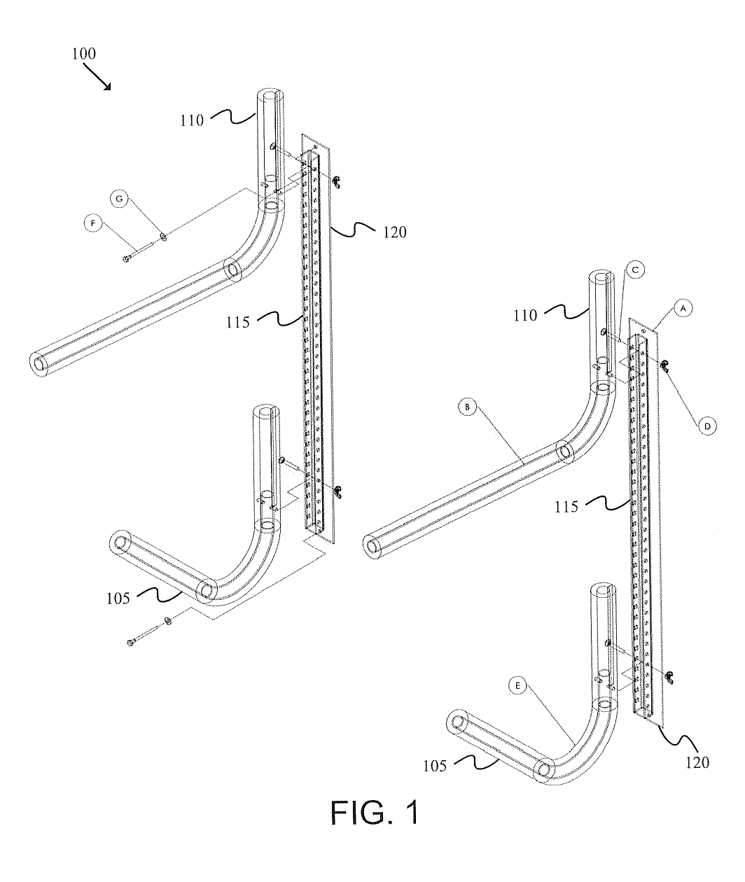

FIG. 1 illustrates a storage rack 100 according to an exemplary embodiment of the invention. As shown, some embodiments may include a first set of loops 105 (e.g., two (18″) eighteen inch loops) and a second set of loops 110 (e.g., two (25″) twenty-five inch loops). Such loops may be covered in an appropriate protective material (e.g., thirty pound neoprene foam). The rack may also include a set of rails 115 (e.g., two thirty-eight inch rails) that may be adapted to accommodate various fasteners (e.g., “U” section punches rails adapted to accommodate carriage bolts).

The rack may also include various other appropriate components (e.g., four hexagonal lag bolts, four carriage bolts, four wing nuts which may be zinc plated, sections of neoprene foam, eight end caps for the loops, a packing box, and/or instructions). Such components may be a various appropriate sizes (e.g., one-quarter inch by three inch hexagonal lag bolts, one-quarter inch by one-and-three-quarter inch carriage bolts, one-quarter inch wing nuts, one-inch inner diameter neoprene foam, one-inch inner diameter end caps, etc.).

Different embodiments may include different numbers of padded loops (e.g., two, six, eight, etc.). In addition, different embodiments may include different numbers of loops attached to each rail (e.g., four loops). The padded loops may be shaped in various appropriate ways (e.g., forty-five degree loops or ninety degree loops as shown in FIG. 1). Each loop may be covered in appropriate padded material to protect the stored equipment. Each loop may be mounted at various vertical positions along a rail.

Each rail may be a u-formed element that has been punched to accommodate carriage bolts (or other appropriate fastener) without requiring any tools. A backing plate 120 (e.g., a three-inch wide section of metal) may be attached to the rail to provide additional support and stability along the vertical surface. The backing plate may be welded to the rail.

During use, each rail may be mounted to an appropriate support (e.g., a wall stud). One or more loops may then be positioned along each rail by moving the loop(s) up or down the rail (e.g., along one-inch discrete increments of a thirty-eight inch rail). Each loop may be secured to a rail using one or more carriage bolts and/or other appropriate fasteners. In this way, different equipment may be appropriately stored using the rack. Some embodiments may allow the loops to be moved and secured without the use of tools.

Different embodiments may include components that include various appropriate materials (e.g., metal, plastic, composite materials, etc.). Different embodiments may be adapted to store various specific materials or elements (e.g., sports equipment, lumber, etc.). Different embodiments may be adapted to support different loads (e.g., up to five hundred pound loads).

It should be understood, of course, that the foregoing relates to exemplary embodiments of the invention and the modifications may be made without departing from the spirit and scope of the invention as set forth in the following claims.

1. A storage rack adapted to store recreations equipment, the storage rack comprising:
a set of rails adapted to be mounted to a vertical surface, each rail of the set of rails comprising a “U” structure having a first sidewall and a second sidewall that are coupled to a backside without a front side, wherein the backside has a particular width with the first sidewall extending perpendicularly from one lateral end of the backside and the second sidewall extending perpendicularly from an opposite lateral end of the backside, and wherein each of the first sidewall and the second sidewall comprises a plurality of circular apertures that are vertically separated by at least one inch and adapted for receiving a bolt;
a first set of supports adapted to be attached to the set of rails, each support of the first set of supports comprising round tubing having a width that is less than or equal to the particular width of each of the set of rails such that the support is adapted to fit in between the first sidewall and the second sidewall of any particular rail of the set of rails, each support further comprising a vertically extending top section and a bottom section extending with at least one of a 45 degree angle and a 90 degree angle from a bottom of the top section, the top section comprising at least one circular aperture, and wherein the top section is secured to the particular rail by (i) inserting the top section in between the first sidewall and the second sidewall of the particular rail, (ii) aligning the top section circular aperture with any of the plurality of circular apertures along the first and second sidewalls, and (iii) sliding a bolt through a circular aperture of the first and second sidewalls that is aligned with the circular aperture of the top section; and
a second set of supports adapted to be attached to the set of rails.

2. A rack system for equipment, comprising:
a main support comprising a “U” shaped section coupled to a backing plate, the “U shaped section comprising a right sidewall that is separated by a particular distance from a left sidewall with a backside in between the left and right sidewall, the left and right sidewalls comprising a plurality of parallel circular openings, and wherein the backing plate has at least one hole usable in securing the main support to a support structure with any of a nail, screw, and bolt;
a holder adapted for insertion through any of the plurality of parallel openings of the left and right sidewalls in order to slideably adjust a position of the holder with respect to the main support; and
a support extension including first and second round tube sections, the first round tube section comprising an extension that protrudes between 45 and 90 degrees from below the second section and is adapted to support one portion of user equipment, and the second round tube section comprising a rigid segment having at least one opening and a width that is less than the particular distance separating the left and right sidewalls, and wherein the support extension couples to the main support by (i) placing the support extension in between the left and right sidewalls, (ii) aligning the support extension opening with any of the plurality of parallel openings of the left and right sidewalls, and (iii) sliding the holder through the aligned openings.

3. (canceled)

4. (canceled)

5. A rack system according to claim 2, wherein the main support is a rail that is offset from a mounting surface of the support structure by the backing plate.

6. A rack system according to claim 2, wherein the main support is made of an aluminum or a steel material.

7. (canceled)

8. (canceled)

9. A rack system according to claim 2, wherein the holder comprises a threaded end and the rack system further comprises a nut that secures to the threaded end of the holder, wherein sliding the holder through one of the plurality of aligned parallel openings of the left and right sidewalls and securing the nut to the threaded end affixes a position of the holder on the main support.

10. A rack system according to claim 2, wherein the support extension is configured to support any of a pair of skis, snowboard, kayak, canoe, ladder, surfboard, paddle board, bicycle, and camping gear.

11.-17. (canceled)

18. A rack system according to claim 2, wherein the rack system is configured to support multiple holders and support extensions.

19. (canceled)

20. A rack system according to claim 2, wherein the support extension is covered in part with neoprene, nylon or other protective material.

21. A rack system according to claim 2, wherein each of the first and second round tube sections is powder coated.

22. A rack system according to claim 2, wherein the holder comprises a head that does not pass through any of the plurality of circular openings and is configured for adjusting a position of the support extension vertically about the main support.

23. A storage rack according to claim 1, wherein each support of the first set of supports further comprises powder coating

24. A storage rack according to claim 1, wherein each support of the first set of supports is at least one of 18 inches long and 25 inches long.

25. A storage rack according to claim 1, wherein the bolt is a carriage bolt comprising a head and circular body with the head being unable to pass through any of the plurality of circular apertures.

26. A storage rack according to claim 25, wherein the carriage bolt is usable in adjusting a position of one of the first set of supports about the plurality of circular apertures of the set of rails without use of any tools.
